(19) United States
(12) Patent Application Publication
(10) Pub. No.: US 2026/0243687 A1
(43) Pub. Date: Aug. 20, 2026

(54) A MULTI-FUNCTIONAL SENSOR FOR MOLECULAR SPECTROSCOPY

(71) Applicant: AGENCY FOR SCIENCE, TECHNOLOGY AND RESEARCH, Singapore (SG)

(72) Inventors: Yi Fan CHEN, Singapore (SG); Nan ZHANG, Singapore (SG); Qing Yang Steve WU, Singapore (SG); Jinghua TENG, Singapore (SG); Sreekanth KANDAMMATHE VALIYAVEEDU, Singapore (SG); Jichao FU, Singapore (SG); Meng ZHAO, Singapore (SG); Shuyan ZHANG, Singapore (SG); Dinish UNNIMADHAVA KURUP SOUDAMINI AMMA, Singapore (SG); Malini OLIVO, Singapore (SG)

(21) Appl. No.: 19/164,308

(22) PCT Filed: Feb. 15, 2024
(86) PCT No.: PCT/SG2024/050081

§ 371 Date: Sep. 11, 2025

(30) Foreign Application Priority Data
Mar. 13, 2023 (SG) 10202300682U

(51) Int. Cl. G01N 21/65; G01N 21/35

(52) U.S. Cl. CPC G01N 21/658; G01N 21/35

(57) ABSTRACT

A sensor substrate includes: a base of silicon; and a plurality of bars. Each of the plurality of bars may be formed of at least a first noble metal. The plurality of bars may be disposed on a first area of the base in an array of units. Each of the units may include: at least one long bar; and at least one short bar. The short bar is shorter in length than the long bar. The array may be a periodic array characterized by a surface enhanced infrared absorption (SEIRA) resonance in an infrared (IR) spectrum. Each of the plurality of bars may include at least one interface characterized by a surface enhanced Raman spectroscopy (SERS) resonance.

### RELATED APPLICATION

This application claims the benefit of priority to the Singapore application no. 10202300682U filed Mar. 13, 2023, the contents of which are hereby incorporated by reference in their entirety for all purposes.

### TECHNICAL FIELD

The present application relates to optical sensors, and more particularly to a substrate for Surface Enhanced Raman Scattering (SERS) and Surface Enhanced Infrared Absorption (SEIRA) spectroscopy.

### BACKGROUND

Surface Enhanced Raman Scattering (SERS) and Surface Enhanced Infrared Absorption (SEIRA) spectroscopy are two useful techniques for optical characterization. Both can be used to provide rapid and label-free identification of the vibrational fingerprints of target molecules. Conventionally, in order to acquire information from both SERS and SEIRA spectra, samples have to be characterized by SERS and by SEIRA separately. The mechanisms for SERS and SEIRA are significantly distinct such that the typical SERS substrate structure is inoperable for the purpose of SEIRA.

### SUMMARY

In one aspect, the present application discloses a sensor substrate includes: a base of silicon; and a plurality of bars. Each of the plurality of bars may be formed of at least a first noble metal. The plurality of bars may be disposed on a first area of the base in an array of units. Each of the units may include: at least one long bar; and at least one short bar. The short bar is shorter in length than the long bar. The array may be a periodic array characterized by a surface enhanced infrared absorption (SEIRA) resonance in an infrared (IR) spectrum. Each of the plurality of bars may include at least one interface characterized by a surface enhanced Raman spectroscopy (SERS) resonance.

The at least one interface may be defined by one of: (i) a plurality of nanoholes distributed in the first noble metal, and (ii) a multi-layer structure disposed on the base, in which the multi-layer structure includes a surface layer formed essentially of the first noble metal and at least one dielectric layer interposed between two metal layers. The at least one interface may be characterized with a plasmonic resonance in a visible wavelength for SERS.

In another aspect, the sensor substrate may further include a thin film disposed on a second area of the base. The thin film may be a planar piece of a metal operable for surface plasmon resonance (SPR). The thin film may be formed of any one of the group consisting of: gold, nickel-silver, and silver. The sensor substrate may be simultaneously operable for SERS sensing, SEIRA sensing, and SPR sensing.

### BRIEF DESCRIPTION OF THE DRAWINGS

Various embodiments will be described with reference to the following figures:

FIG. 1 is a schematic diagram of a sensor substrate according to various embodiments of the present disclosure;

FIG. 2 shows scanning electron microscope (SEM) images of an example of the sensor substrate of FIG. 1, with a multi-layer metal-dielectric-metal structure;

FIG. 3 shows SEM images of prototypes of the sensor substrate according to another embodiment of the present disclosure;

FIG. 4 shows the SERS characterization obtained using an example of the sensor substrate with random holes;

FIG. 5 shows the SERS characterization obtained using an example of the sensor substrate with patterned holes;

FIG. 6 shows the reflection spectra for an example of the sensor substrate with random holes;

FIG. 7 shows the reflection spectra for an example of the sensor substrate with patterned holes in comparison with the spectrum of a reference SEIRA substrate;

FIG. 8 shows the simulated reflectance spectrum of a SEIRA sensor substrate;

FIG. 9 shows the simulation results of a plasmonic-induced field distribution/enhancement on a multi-layer structure; and

FIG. 10 shows a schematic diagram of a 3-in-1 sensor substrate according to another embodiment of the present disclosure.

### DETAILED DESCRIPTION

The following detailed description is made with reference to the accompanying drawings, showing details and embodiments of the present disclosure for the purposes of illustration. Features that are described in the context of an embodiment may correspondingly be applicable to the same or similar features in the other embodiments, even if not explicitly described in these other embodiments. Additions and/or combinations and/or alternatives as described for a feature in the context of an embodiment may correspondingly be applicable to the same or similar feature in the other embodiments.

In the context of various embodiments, the articles “a”, “an” and “the” as used with regard to a feature or element include a reference to one or more of the features or elements.

In the context of various embodiments, the term “about” or “approximately” as applied to a numeric value encompasses the exact value and a reasonable variance as generally understood in the relevant technical field, e.g., within 10% of the specified value.

As used herein, the term “and/or” includes any and all combinations of one or more of the associated listed items.

The word “exemplary” is used herein to mean “serving as an example, instance, or illustration.” Any embodiment described herein as “exemplary” is not necessarily to be construed as preferred or advantageous over other embodiments. As used herein, the singular ‘a’ and ‘an’ may be construed as including the plural “one or more” unless apparent from the context to be otherwise.

Terms such as “first” and “second” are used in the description and claims only for the sake of brevity and clarity, and do not necessarily imply a priority or order, unless required by the context. The terms “about” and “approximately” as applied to a stated numeric value encompasses the exact value and a reasonable variance as will be understood by one of ordinary skill in the art, and the terms “generally” and “substantially” are to be understood in a comparable manner, unless otherwise specified.

Some methods may be described in terms of steps merely to aid understanding and/or for convenient reference. The delineation between one step and another step may be merely for convenient reference in the present disclosure. It will be understood that in actual implementation there may not be a clear division or transition from one step to another subsequent step. There may be a certain amount of overlap among the steps and/or more than one step may occur or be performed concurrently in time, etc.

### Sensor Substrate

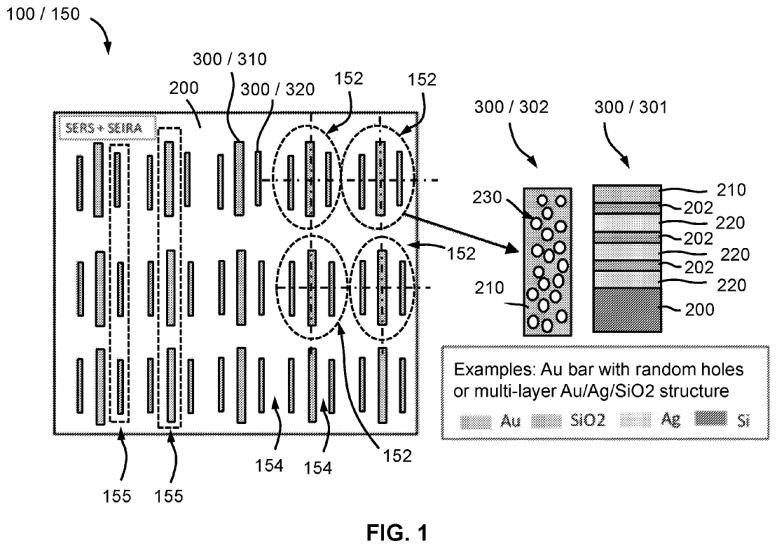

FIG. 1 shows a schematic diagram of the proposed sensor substrate 100 according to various embodiments of the present disclosure.

The sensor substrate 100 includes an array 150 of bars 300 disposed on a base 200, configured to simultaneously perform SERS and SEIRA signal enhancement. The array 150 disposed on the base 200 may be described as a dual SERS-SEIRA substrate. As used herein, the term “bars” refers to elongate structures or structures each having a generally elongated shape. The array 150 may be described in terms of units 152 disposed in a repeated pattern over an area of the base 200. Each unit 152 of the array 150 may include at least one short bar 320 and at least one long bar 310, in which the long bar 310 has a length that is longer than that of the short bar 320.

In some embodiments, each of the long bars 310 may have a length dimension in the micrometer scale, e.g., a length greater than 1 micrometer. In some embodiments, each of the long bars 310 may have a width dimension in the nanometer scale, e.g., a width less than 1 micrometer. In some embodiments, each of the short bars 320 may have a length dimension in the nanometer scale, e.g., a length of about 1 micrometer or less. In some embodiments, each of the short bars 320 may have a width dimension in the nanometer scale, e.g., a width that is significantly less than the length of the short bar.

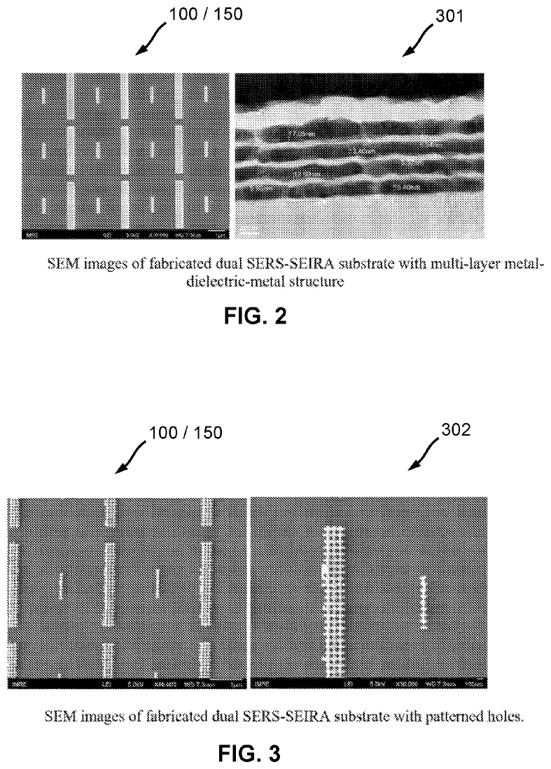

As used herein, the term “nanoscale” or “nanometer scale” refers to dimensions about 1000 nm or smaller than 1000 nm. Correspondingly, as used herein, the terms “nanostructures” and “nanoholes” refer respectively to structures and holes with dimensions generally smaller than 1000 nm or no greater than 1000 nm or about 1000 nm. To further illustrate, prototypes of sensor substrates 100 in FIG. 2 and FIG. 3 include short bars with a width of about 100 nm (nanometers). The plurality of bars 300 (e.g., including the long bars 310 and the short bars 320) of the same sensor substrate 100 may have generally similar widths. In some embodiments, the long bars 310 and the short bars 320 have different widths.

In the array 150, the plurality of bars 300 may be disposed on the base 200 to form various repeated patterns over the area of the sensor substrate. The array of bars collectively provides an area with multiple “channels” 154 defined between neighboring or adjacent ones of the bars 300. The widths of the channels 154 (e.g., the inter-bar spacing) may be varied from one substrate 100 to another. The bars 300 are disposed on the base 200 with the respective lengths of the bars extending along a reference plane defined by a major surface of the base 200. The bars 300 may be aligned in parallel rows 155 that are spaced apart from one another. Each bar 300 may be spaced apart from its neighboring bar(s) along the same row 155.

In some examples, the plurality of bars 300 are disposed in parallel rows 155, with long bars 310 and short bars 320 disposed in alternate rows 155. In some other examples, the array of bars 300 includes a repeated unit 152, in which the unit 152 includes one long bar 310 flanked by a short bar 320 on either side of the long bar 310.

In some examples, the array 150 may be described as a planar grid or lattice arrangement in which a unit of the array is disposed at each corner of the grid.

In some examples, each of the bars 300 (e.g., each of the long bars 310 and each of the short bars 320) is formed by at least one noble metal. In some examples, the noble metal of the bars 300 may be one selected from the group consisting of gold (Au) and silver (Ag).

### Multi-Layer Structure

According to embodiments of the present disclosure, the array 150 of bars 300 provides SEIRA-active structures, in which each bar includes alternating layers of metal-dielectric-metal materials or a plurality of holes. The plurality of bars may be configured with a resonance in the infrared absorption spectra of the desired detecting molecules.

According to some embodiments, each of the bars 300 is a multi-layer structure 301 as shown schematically in FIG. 1 and in the cross-sectional SEM image of FIG. 2. For example, each long bar 310 and each short bar 320 may include multiple layers of different materials. In some examples, the multiple layers may be layers of a dielectric material 202 interleaved with interleaving metal layers 220 of a metal. In some examples, the dielectric layer 202 is a metal oxide. In some examples, the multiple layers may be layers of the metal oxide interleaved with layers of a metal, in which the layers of metal may be formed of a noble metal (such as but not limited to silver) in some cases or another metal (such as but not limited to aluminum) in other cases. In some examples, the multi-layer structure 301 may include alternating layers of a dielectric material and a metal, with a surface layer 210 being formed of a noble metal characterized by a relatively high Raman enhancement factor, such as gold.

The dielectric material may be one selected from the following: silicon dioxide (SiO₂), In some examples, the noble metal is one selected from the following: gold (Au) and silver (Ag).

For example, each bar 300 may include a multi-layer stack 301 in the form of: Ag/SiO₂/Ag/SiO₂/Ag/SiO₂/Au, disposed on a silicon base 200, and in which Au forms the surface layer 210.

In some examples, a first layer of silver may be formed on a base (such as but not limited to silicon), a second layer of silicon dioxide may be formed on the first layer, a third layer of silver may be formed on the second layer, a fourth layer of silicon dioxide may be formed on the third layer, a fifth layer of silver may be formed on the fourth layer, a sixth layer of silicon dioxide may be formed on the fifth layer, and a seventh layer of gold may be formed on the sixth layer. In these examples, the seventh layer is the surface layer. The surface layer 210 is formed from a noble metal, such as but not limited to gold.

In some examples, the multi-layer structure 301 includes layers of a first noble metal alternately disposed with layers of a dielectric material, in which the multi-layer structure includes a surface layer of a second noble metal. In some embodiments, the second noble metal is characterized by a Raman enhancement factor higher than that of the first noble metal.

Bars with Holes

In other embodiments (alternative to the multi-layer structure), each bar 300 may be formed with a plurality of holes 230 in the body of the bar, in which each of the holes 230 is nano-sized. For the sake of brevity, a bar with holes may also be referred to as a “pitted bar” 302. For example, the diameter of each hole 230 is in the nanometer scale, e.g., in a range smaller than 200 nm. The SEM images of FIG. 3 show examples of bars with holes, cavities, or concave features on the terminal surfaces as well as on the side surfaces of the bars. In some embodiments, a plurality of open holes are distributed over at least the terminal surface of the pitted bar 302. For the sake of convenient reference, the surface of a bar facing away from the substrate is referred to herein as the “terminal surface”. As used herein, the terms “holes”, “cavities”, “concave features”, etc., may be understood to include open holes, e.g., holes in the form of a hollow space or indented space in the body of the bar in which the hollow space is in fluid communication with the external environment.

In some embodiments, the body of each pitted bar 302 (e.g., each short bar 320 and each long bar 310) may be a metal bar 210 formed wholly of a noble metal. Each of the pitted bars 302 may be formed of a noble metal, such as but not limited to gold and silver.

In some embodiments, the holes 230 are randomly distributed on at least the sensing surface of each pitted bar 302 (as illustrated in FIG. 1). For the sake of brevity, such holes 230 are referred to as random holes. Random holes may include randomly distributed (randomly positioned) holes, e.g., holes of similar sizes randomly located on at least one surface of the bar. Random holes may include randomly distributed holes of various (randomly determined) sizes.

In some other embodiments, the holes 230 are distributed on at least one surface of a pitted bar in a regular manner or a pattern (e.g., as shown in the SEM images of FIG. 3). For the sake of brevity, such holes 230 may be interchangeably referred to as patterned holes or periodic holes. Patterned holes may include holes of generally the same size. Patterned holes may include holes of various sizes on the same pitted bar 302. Patterned holes may include holes that are regularly spaced apart from one another. Patterned holes may be spaced apart from neighboring patterned holes by a similar inter-hole spacing throughout the pitted bar 302. Patterned holes may form an array of holes on a bar 300/302.

### Experiments

### Multi-Layer Bars

In one experiment, electron beam lithography (EBL) was used in the fabrication of the proposed sensor chip. In this process, polymethyl methacrylate (PMMA 950 A5):isopropyl alcohol (IPA) 1:1 solution was spin-coated on an undoped silicon wafer at 3000 revolutions per minute (rpm) for 90 seconds, and hot plate cured at 180° C. for 2 minutes. The electron beam current setting was 500 picoAmperes (pA), 100 kiloVolts (kV), and dosage 0.6 microCoulomb per centimeter square (μC/cm²). After exposure, the sample was dipped into methyl isobutyl ketone (MBK):IPA 1:3 solution for 1 minute, followed by rinsing and blow drying.

The resulting patterned samples of PMMA were placed into an e-beam evaporation chamber for metal deposition.

To fabricate the sandwiched or multi-layer metal-dielectric-metal stack structure shown in the SEM images of FIG. 2, alternating layers of Ag and SiO₂ with thicknesses of 10 nm (or about 10 nm) and 5 nm (or about 5 nm) respectively were deposited, with the top layer (also referred to as the surface layer) being Au. From the top layer or the surface layer, the stack structure (from top) may be: Au/SiO₂/Ag/SiO₂/Ag/SiO₂/Ag/base.

A lift-off process was carried out using acetone solution to remove the extra film of PMMA, followed by washing in IPA solution and deionized (DI) water, and blow drying by nitrogen (N₂) gun.

Bars with Holes

To fabricate the pitted bar structure as shown in the SEM images of FIG. 3, nano-sized holes are formed in the bars.

In one experiment, PMMA:IPA 1:1 solution was spin-coated on an undoped silicon wafer at 3000 revolutions per minute (rpm) for 90 seconds, and hot plate cured at 180° C. for 2 minutes. The samples were then subjected to EBL with a current setting of 500 pA, 100 kV, and dosage 0.6 μC/cm². After exposure, the samples were dipped into MBK:IPA 1:3 solution for 1 minute, followed by rinsing and blow drying.

The resulting patterned samples of PMMA were placed into an e-beam evaporation chamber for metal deposition of a noble metal. Instead of alternately depositing layers of metal and dielectric, a metal such as Au or Ag was selected for deposition on the pre-patterned PMMA. The fabrication process is similar except that a metal such as Au or Ag to the pre-patterned PMMA, in place of depositing alternating layers of metal-dielectric-metal, etc.

### Measurements

SERS and SEIRA characterizations were conducted experimentally.

For SERS measurement, the samples were incubated in 1 mM Rhodamine 6G (R6G) solution overnight. The WITec PSTM system with a 532 nm laser (available from Oxford Instruments) was used for SERS measurements.

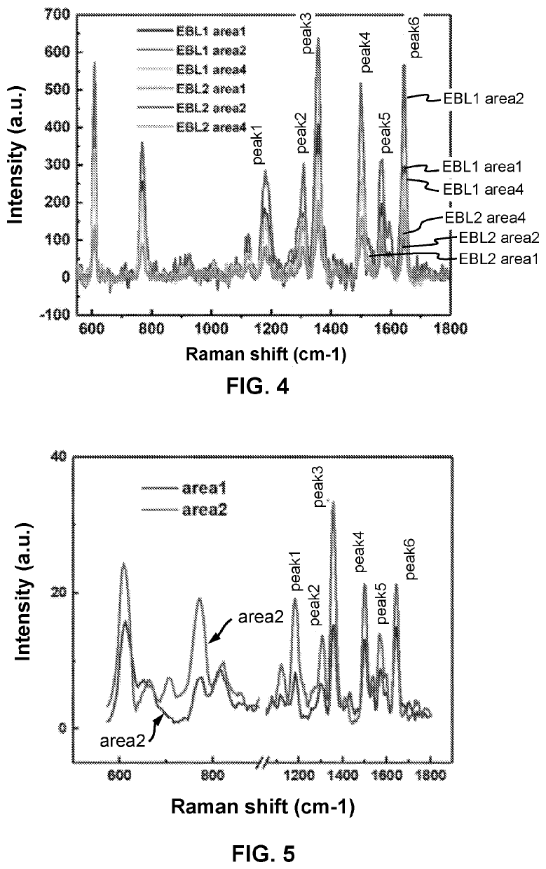

The measured Raman signals of R6G using random holes and patterned holes substrates are shown in FIG. 4 and FIG. 5, respectively. As can be seen, six enhanced Raman peaks could be identified. After considering the effective area, the intensity of peak 3 and peak 4 were compared with the intensity of the substrate with multi-layer bars. It is clear from the comparison results shown in Table 1 that the enhancement factor of the pitted bar substrate is comparable and even better performing in some cases.

TABLE 1
Intensity comparison between patterned surface and whole surface

| | EBL1 | EBL1 | EBL1 | EBL2 | EBL2 | EBL2 | Multilayer |
|---|---|---|---|---|---|---|---|
| | area1 | area2 | area4 | area1 | area2 | area4 | sample |
| Peak3 | 3142.77 | 4905.15 | 2502.92 | 1555.61 | 1145.46 | 1426.53 | 1323.2 |
| (a. u.) | | | | | | | |
| Peak4 | 1961.77 | 3986.53 | 1810 | 1198.69 | 802.31 | 1135.38 | 1056 |
| (a. u.) | | | | | | | |

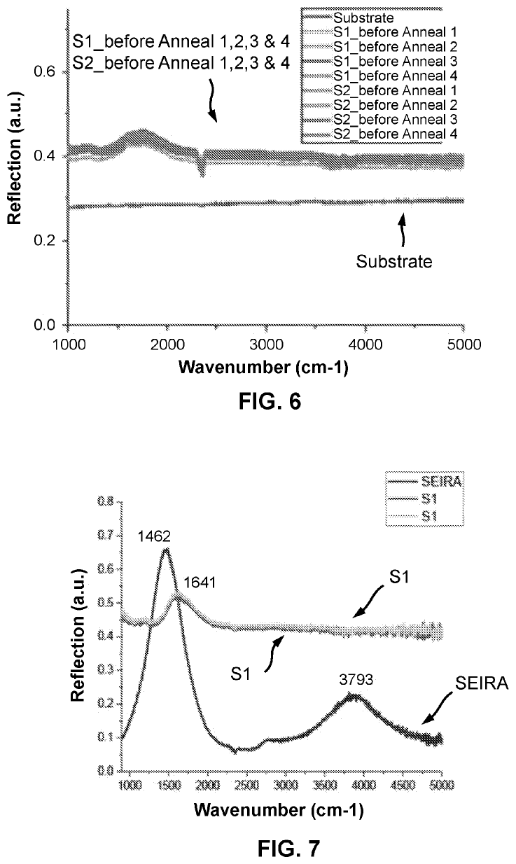

SEIRA measurement in a reflection mode was performed using a microscope based Fourier transform infrared (FTIR) system (Hyperion 2000 available from Bruker Optics), in which a Globar as an illumination source and a liquid nitrogen-cooled MCT (mercury-cadmium-telluride) detector were used. Infrared reflection spectra of the random holes substrates and patterned holes substrates are shown in FIG. 6 and FIG. 7, respectively.

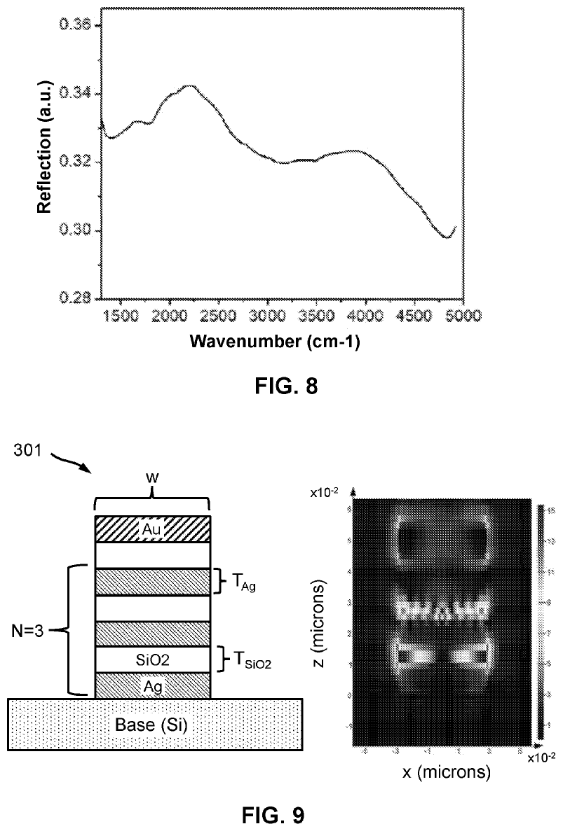

A FTIR reflectance spectrum was numerically simulated using a three-dimensional finite-difference time-domain (3D FDTD) model (Lumerical FDTD software available from Ansys). In the simulation, periodic boundary conditions were used along the x- and y-axis, and a perfectly matched layer (PML) was used along z-direction. As shown in FIG. 8, the simulated reflectance spectrum correlated well with the experimental reflectance spectra.

The electromagnetic response of the multi-layer metal-dielectric-metal structure under an incident plane wave was simulated using the Lumerical FDTD software. The scattering/absorption cross sections and electric field intensity for different wavelengths were calculated. Field enhancement at the edge of the structure can be seen in FIG. 9. The simulation results indicate that the multi-layer structure shows a tunability in responding wavelength and a strong electric field enhancement, and the proposed sensor substrate is a promising device for SERS application.

### 3-In-1 Sensor Chip

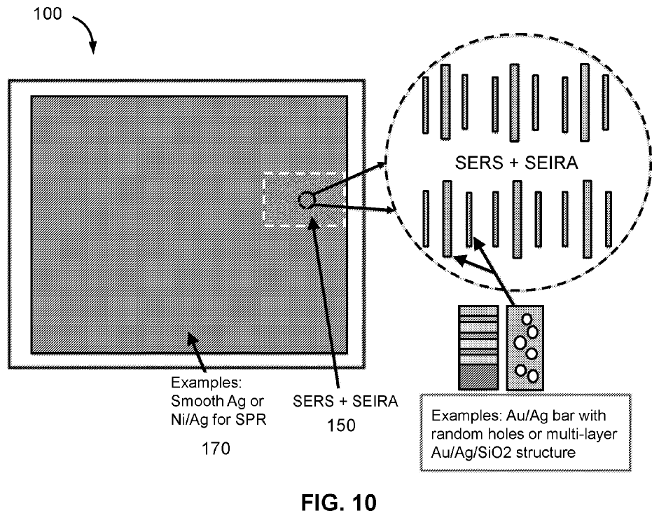

FIG. 10 is a schematic diagram of a 3-in-1 sensor substrate 100 according to another embodiment of the present disclosure. The proposed 3-in-1 sensor substrate is simultaneously operable by three mechanisms, namely, SERS, SEIRA, and SPR (surface plasmon resonance).

In some examples, the sensor substrate may be described as a dual SERS and SEIRA sensor further integrated with a comparatively large area deposited with a thin film of Ag or Ni/Ag film for SPR. The relative position and sensing area for SERS, SEIRA, and SPR can be varied according to the substrate and characterization tools.

Alternatively described, according to some embodiments, the sensor substrate includes: (i) a periodic short/long bar structure including metal (for resonance in infrared (IR) range for SEIRA); (ii) bars configured for SERS, each of the bars being one of a multi-layer metal-dielectric-metal stack or a pitted bar with random holes or patterned holes; and a pattern-free or substantially planar area of Au or Ag for SPR.

### Applications and Advantages

The foregoing describes various embodiments of a unique sensing chip that can be used simultaneously for both SERS and SEIRA characterization. In the IR range for mRNA IR absorption spectrum detectable by SEIRA, the conventional SEIRA substrate would have minimal effect on the surface plasmon enhanced Raman scattering. In the present disclosure, the proposed sensor substrate further includes the Au pitted bar and/or the multi-layer Ag/SiO₂ bar (with random and/or periodic holes) to provide surface enhanced Raman spectroscopy. By providing many nanoholes in the Au bar or by providing a multilayer metal-dielectric-metal structure to replace the Au bar, the plasmonic resonance can be greatly enhanced through either the localized surface plasmon in many nanoholes or the gap plasmon in the metal-dielectric-metal structures. The SERS structure may have a random hole structure patterned together with the SEIRA structure or a random mesh structure through annealing of deposited metal or multi-layer metal-dielectric-metal structure. Using this approach, one single chip capable of working simultaneously for both SERS and SEIRA can be achieved.

Advantageously, the SERS structure can be manufactured with a multi-layer metal-dielectric-metal structure through processes such as thin film deposition and lift-off, and be easily scalable. All the structures may be fabricated in one-go and can subsequently be simultaneously used for both or either applications. The SERS structure can have a random hole structure patterned together with the SEIRA structure or a random mesh structure through annealing of deposited metal or multi-layer metal-dielectric-metal structure.

The SERS structure can have a top-most Au layer (e.g., Au surface layer) and the other multi-layer metal-dielectric-metal layers can be Ag—SiO₂—Ag. The periodic short/long metal bar structure is tunable and configurable to be resonant with the target molecule absorption spectrum.

In some embodiments, the 2-in-1 sensor substrate may be expanded to 3-in-1 functionality by incorporating a flat or substantially flat Au or Ag region for SPR. The sensing chip can be further extended to have 3-in-1 sensing functions simultaneously for SERS, SEIRA and SPR, and used for providing additional quantitative information about the concentration of the target molecules.

The proposed sensor substrate can find many practical applications, including for example, bio-sensing, mRNA and DNA identification, cancer diagnosis, pollution analysis, gas sensing such as detection of volatile organic compounds.

The single sensor chip for both SERS and SEIRA applications proposed herein can be used for detecting the vibrational fingerprints of different biomolecules from visible to infrared. This has been shown to be potentially useful for real-time point-of-care applications, e.g., SERS substrates with specially-configured SEIRA targeting mRNA in breast cancer cells have been developed.

The proposed sensor substrate can simultaneously provide complementary information for materials identification and/or molecular identification, in which the complementary information is obtained by different mechanisms, including but not limited to SEIRA and SERS. In situations where the target materials or target molecules are present in such low concentrations that the Raman signals alone are weak, the higher sensitivity of the SERS signal would nonetheless enable the sensor chip to detect the target materials or target molecules. In other situations, such as when the wavelengths are in the infrared (IR) range, the nanophotonic structure of the sensor chip remains operable for enhancing absorption in the IR range by the SEIRA mechanism. The proposed sensor chip can therefore provide a higher degree of data accuracy when compared to characterization by a conventional SERS substrate or a conventional SEIRA substrate.

The single sensor chip that can be used for both SERS and SEIRA would advantageously require a smaller sample volume since the number of samples required for conducting both SERS and SEIRA characterization can be reduced. The overall process for sample preparation and characterization can also be more efficient, since multiple characterization processes would take place simultaneously instead of sequentially.

Advantageously, the comparatively simple geometry of the bars has good reproducibility. Prototypes of the sensor substrate were made using a top-down fabrication. The proposed sensor substrate can also be made using bottom-up fabrication.

In the experiments, the SEIRA spectra were measured at normal incidence. In the proposed sensor substrate, the SEIRA spectra need not be collected at high angles of incidence (such as) 80°. The proposed sensor substrate may be described as providing an angle-independent plasmonic structure that is useful for many practical SEIRA applications.

The proposed structure can be used to realize both SERS and SEIRA simultaneously because it supports resonance at infrared wavelength for SEIRA and plasmonic resonance in the visible wavelength for SERS.

According to various embodiments of the present disclosure, a sensor substrate includes: a base of silicon; and a plurality of bars. Each of the plurality of bars may be formed of at least a first noble metal. The plurality of bars may be disposed on a first area of the base in an array of units. Each of the units may include: at least one long bar; and at least one short bar. The short bar is shorter in length than the long bar. The array may be a periodic array characterized by a surface enhanced infrared absorption (SEIRA) resonance in an infrared (IR) spectrum. Each of the plurality of bars may include at least one interface characterized by a surface enhanced Raman spectroscopy (SERS) resonance.

The at least one interface is defined by one of: (i) a plurality of nanoholes distributed in the first noble metal, and (ii) a multi-layer structure disposed on the base, in which the multi-layer structure includes a surface layer formed essentially of the first noble metal and at least one dielectric layer interposed between two metal layers.

The at least one interface may be characterized with a plasmonic resonance in a visible wavelength for SERS.

The plurality of nanoholes may be distributed in the first noble metal in a repeated pattern.

The plurality of nanoholes may be distributed in the first noble metal in a random distribution.

The plurality of nanoholes may be of various sizes. Alternatively, the plurality of nanoholes may be of a similar size.

The multi-layer structure may include at least one dielectric layer disposed immediately adjacent the surface layer, and in which the multi-layer structure includes at least one layer of a second metal alternating with at least one dielectric layer.

The multi-layer structure may include at least one metal-dielectric-metal structure disposed between the surface layer and the base.

The multi-layer structure may include at least one dielectric layer interposed between two metal layers, in which at least one of the two metal layers is formed of the first noble metal.

The multi-layer structure may include at least one dielectric layer interposed between two metal layers, in which at least one of the two metal layers is formed of the second metal.

The first noble metal may consist of gold.

The second metal may consist of silver or aluminum.

Each of the at least one dielectric layer may be formed of silicon dioxide or aluminum oxide.

The plurality of bars may be formed by one of a top-down process and a bottom-up process to form the following structure: silicon/silver/silicon dioxide/silver/silicon dioxide/silver/silicon dioxide/gold, in which the base is formed of the silicon, and in which the surface layer is formed of the gold.

Each of the at least one long bar and the at least one short bar may be an elongate structure characterized by a width in a nanometer scale.

The array may include a grid array, in which each of the units is disposed in a respective corner of the grid array.

The sensor substrate may be simultaneously operable for SERS sensing and SEIRA sensing.

The sensor substrate may further include a thin film disposed on a second area of the base. The thin film may be a planar piece of a metal operable for surface plasmon resonance (SPR). The thin film may be formed of any one of the group consisting of: gold, nickel-silver, and silver. The thin film may consist of one or more thin layers of the following: gold, silver, and nickel. For example, a thin film of nickel-silver may be formed by providing a thin film of nickel (Ni), such as but not limited to 5 nm of a Ni thin film as a seeding layer, followed by forming a thin film of Ag on the Ni thin film.

The sensor substrate may be simultaneously operable for SERS sensing, SEIRA sensing, and SPR sensing.

All examples described herein, whether of apparatus, methods, materials, or products, are presented for the purpose of illustration and to aid understanding, and are not intended to be limiting or exhaustive. Modifications may be made by one of ordinary skill in the art without departing from the scope of the claimed invention.

1. A sensor substrate comprising:
a base of silicon; and
a plurality of bars, each of the plurality of bars being formed of at least a first noble metal, the plurality of bars being disposed on a first area of the base in an array of units, each of the units including:
at least one long bar; and
at least one short bar, the short bar being shorter in length than the long bar,
wherein the array is a periodic array characterized by a surface enhanced infrared absorption (SEIRA) resonance in an infrared (IR) spectrum,
and wherein each of the plurality of bars includes at least one interface characterized by a surface enhanced Raman spectroscopy (SERS) resonance.

2. The sensor substrate as recited in claim 1, wherein the at least one interface is defined by one of: (i) a plurality of nanoholes distributed in the first noble metal, and (ii) a multi-layer structure disposed on the base, the multi-layer structure including a surface layer formed essentially of the first noble metal and at least one dielectric layer interposed between two metal layers.

3. The sensor substrate as recited in claim 2, wherein the at least one interface is characterized with a plasmonic resonance in a visible wavelength for SERS.

4. The sensor substrate as recited in claim 2, wherein the plurality of nanoholes are distributed in the first noble metal in a repeated pattern.

5. The sensor substrate as recited in claim 2, wherein the plurality of nanoholes are distributed in the first noble metal in a random distribution.

6. The sensor substrate as recited in claim 2, wherein the plurality of nanoholes are of various sizes.

7. The sensor substrate as recited in claim 2, wherein the plurality of nanoholes are of a similar size.

8. The sensor substrate as recited in claim 2, wherein the multi-layer structure comprises at least one dielectric layer disposed immediately adjacent the surface layer, and wherein the multi-layer structure includes at least one layer of a second metal alternating with at least one dielectric layer.

9. The sensor substrate as recited in claim 8, wherein the multi-layer structure comprises at least one metal-dielectric-metal structure disposed between the surface layer and the base.

10. The sensor substrate as recited in claim 8, wherein the multi-layer structure comprises at least one dielectric layer interposed between two metal layers, and wherein at least one of the two metal layers is formed of the first noble metal.

11. The sensor substrate as recited in claim 8, wherein the multi-layer structure comprises at least one dielectric layer interposed between two metal layers, and wherein at least one of the two metal layers is formed of the second metal.

12. The sensor substate as recited in claim 8, wherein first noble metal consists of gold.

13. The sensor substrate as recited in claim 8, wherein the second metal consists of silver or aluminum.

14. The sensor substrate as recited in claim 8, wherein each of the at least one dielectric layer is formed of silicon dioxide or aluminum oxide.

15. The sensor substrate as recited in claim 2, wherein the plurality of bars are formed by one of a top-down process and a bottom-up process to form the following structure: silicon/silver/silicon dioxide/silver/silicon dioxide/silver/silicon dioxide/gold, and wherein the base is formed of the silicon, and wherein the surface layer is formed of the gold.

16. The sensor substrate as recited in claim 1, wherein each of the at least one long bar and the at least one short bar is an elongate structure characterized by a width in a nanometer scale.

17. The sensor substrate as recited in claim 1, wherein the array comprises a grid array, and wherein each of the units is disposed in a respective corner of the grid array.

18. The sensor substrate as recited in claim 1, wherein the sensor substrate is simultaneously operable for SERS sensing and SEIRA sensing.

19. The sensor substrate as recited in claim 1, further comprising a thin film disposed on a second area of the base, the thin film being a planar piece of a metal operable for surface plasmon resonance (SPR), and wherein the thin film is formed of any one of the group consisting of: gold, nickel-silver, and silver.

20. The sensor substrate as recited in claim 19, wherein the sensor substrate is simultaneously operable for SERS sensing, SEIRA sensing, and SPR sensing.
